(19) United States
(12) Patent Application Publication
(10) Pub. No.: US 2023/0281636 A1
(43) Pub. Date: Sep. 7, 2023

(54) SYSTEMS AND METHODS FOR GENERATING CUSTOMER EXPERIENCE SCORES

(71) Applicant: Cox Communications, Inc., Atlanta, GA (US)

(72) Inventors: Brad Pfaff, Atlanta, GA (US); London Lamb, Atlanta, GA (US); Ryan Carroll, Atlanta, GA (US); Damon Hansen, Atlanta, GA (US); Bryana Benson, Atlanta, GA (US); Brian Stublen, Atlanta, GA (US); Brandy Riherd, Atlanta, GA (US); Ben Vijayakumar, Atlanta, GA (US); Kieran Ram, Atlanta, GA (US); Christian Welin, Atlanta, GA (US)

(73) Assignee: Cox Communications, Inc., Atlanta, GA (US)

(21) Appl. No.: 17/653,706

(22) Filed: Mar. 7, 2022

(51) Int. Cl. G06Q 30/00; G06Q 30/02

(52) U.S. Cl. CPC G06Q 30/016; G06Q 30/0282

(57) ABSTRACT

Disclosed are systems and methods for generating customer experience scores. An example method may include determining, via a processor, a first event impacting one or more users on a network. The example method may also include determining, via the processor, a first time period during which the first event occurs. The example method may also include determining, via the processor, a first number of interactions that occurred during the first time period between the one or more users and a network service provider. The example method may also include determining, via the processor and using a correlation model, a first relationship between the first event and the first number of interactions during the first time period. The example method may also include determining, via the processor, a second event impacting a first user. The example method may also include determining, using the machine learning model and based on the second event, a first metric indicative of an experience of the first user, wherein the first event and second event are a same type of event.

### BACKGROUND

Cable providers today do not have a comprehensive way of quantifying the overall quality of a customer’s experience with a network. Currently, it may be difficult to discern if the customer is experiencing an issue, and it may also be challenging to determine the severity or the duration of their issue apart from the customer’s report due to the potential complexity of a network ecosystem. Intermittent issues at a customer level are particularly difficult to identify.

### BRIEF DESCRIPTION OF THE DRAWINGS

FIG. 1 is an example use case, in accordance with one or more embodiments of the disclosure.

FIG. 2 is an example block diagram, in accordance with one or more embodiments of the disclosure.

FIG. 3 is an example events plot, in accordance with one or more examples of the disclosure.

FIG. 4 is an example listing of types of events, in accordance with one or more examples of the disclosure.

FIG. 5 is an example listing of types of interactions, in accordance with one or more examples of the disclosure.

FIG. 6 is an example listing of types of event profiles, in accordance with one or more examples of the disclosure.

FIG. 7 is an example representation of an action layer, in accordance with one or more examples of the disclosure.

FIG. 8 is an example flow diagram, in accordance with one or more examples of the disclosure.

FIG. 9 is an example visualization of one or more metrics, in accordance with one or more examples of the disclosure.

FIG. 10 is an example visualization of one or more metrics, in accordance with one or more examples of the disclosure.

FIG. 11 is an example method, in accordance with one or more embodiments of the disclosure.

FIG. 12 is an example system, in accordance with one or more embodiments of the disclosure.

FIG. 13 is an example system, in accordance with one or more embodiments of the disclosure.

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. The use of the same reference numerals indicates similar but not necessarily the same or identical components; different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

### DETAILED DESCRIPTION

This disclosure relates to, among other things, systems and methods for generating customer experience scores. Particularly, the systems and methods may relate to customers of a cable network and may involve producing one or more metrics that may be used to quantify a customer’s experience regardless of whether the customer provides an indication of their experience. These same systems and methods may also be used to predict these same types of metrics for future customer experiences associated with predicted events that have not yet occurred. These same systems and methods may also be applicable in other contexts as well, and any descriptions herein relating to a network are not intended to be limiting.

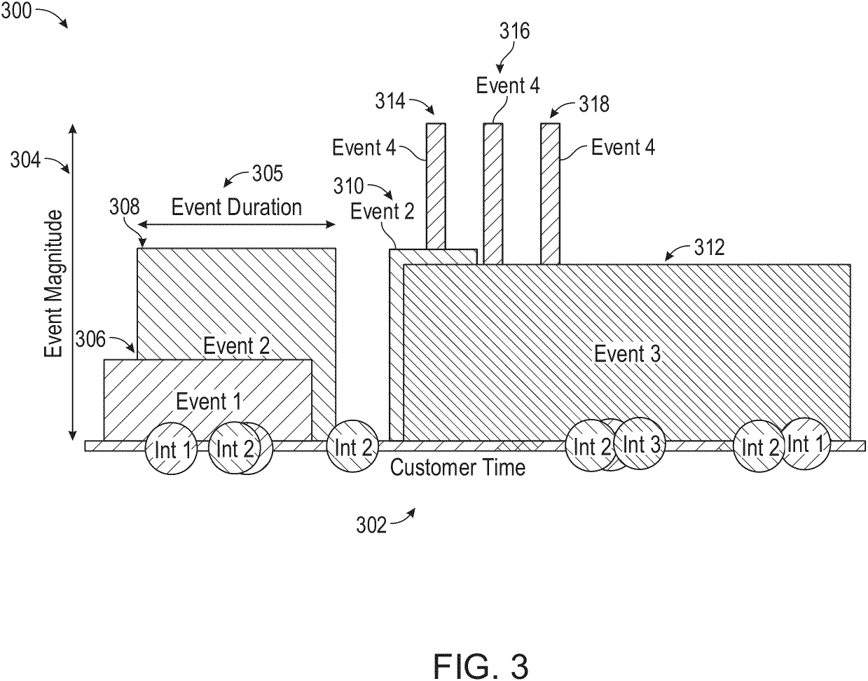

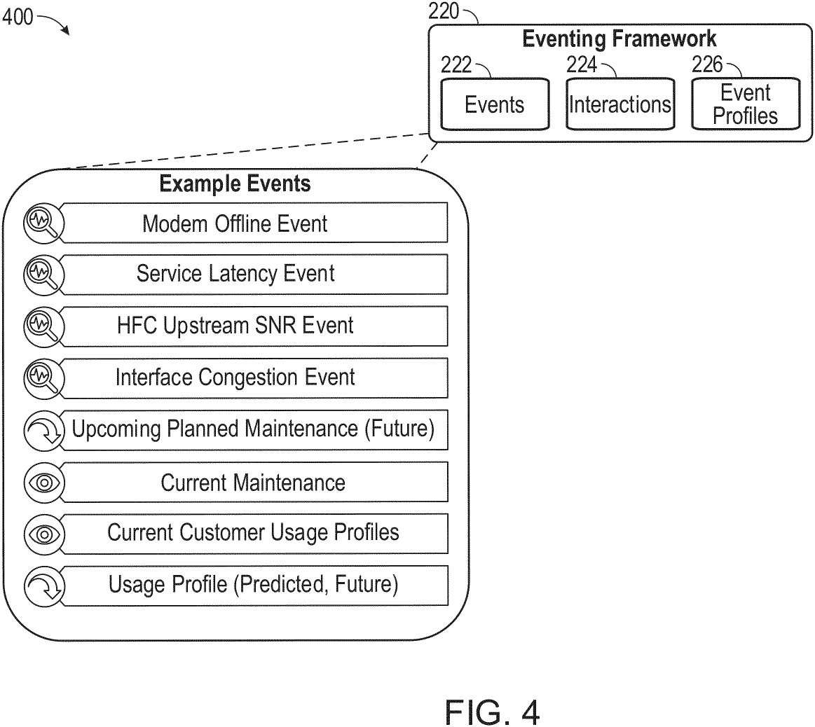

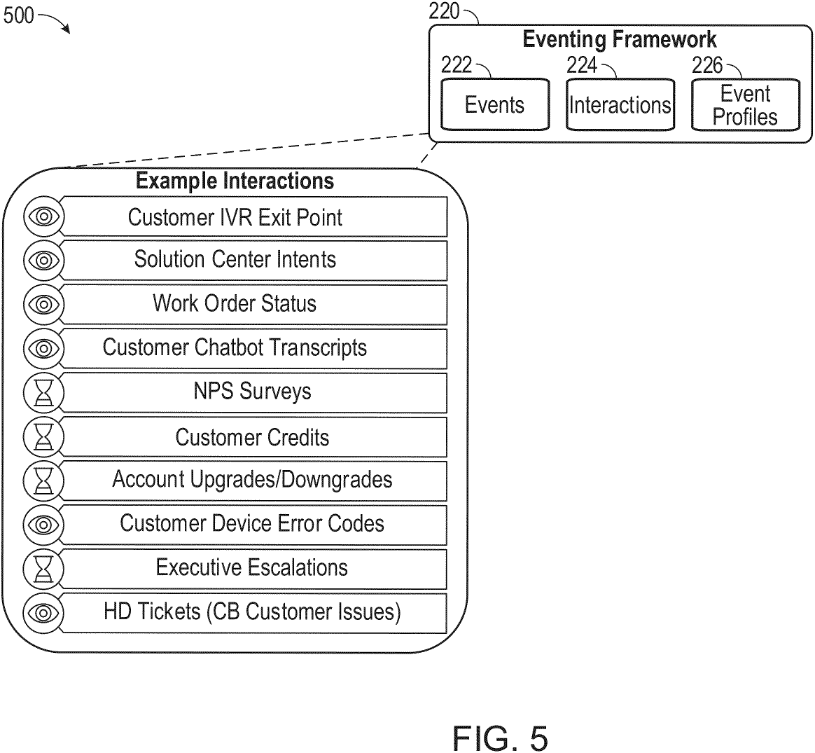

In one or more embodiments, the generation of the one or more metrics may involve training one or more models (for example, correlation models, artificial intelligence models, machine learning models, or the like) using data obtained from an aggregate of customers. Once the models are trained, they may then be applied at the individual customer level to make predictions for individual customers. At a high-level, this initial training of the models may involve identifying at least one or more events (non-limiting examples of types of events are presented with respect to FIG. 4) that occur within a given time frame, a length of each event, and a number of customer interactions (non-limiting examples of types of interactions are presented with respect to FIG. 5) that take place during these time periods. Based on this data, correlations between the events and the interactions may be established to determine the relative impact of each event for a customer or aggregate of customers. These correlations, in turn, may be used to train the models. The trained models may then be applied to individual customers to predict a customer’s experience with the service, which may be quantified through the one or more metrics, for example. As one non-limiting example, the correlations may be used to establish a “magnitude” (for example, a value) associated with a given type of event. This magnitude may then be applied to events experienced by an individual customer (as illustrated through FIG. 3, for example). The one or more metrics (as well as any other relevant information) may be visualized, and actions may automatically be triggered to mitigate or eliminate the impact of any current and/or future events on a customer.

In one or more embodiments, an example of the one or more metrics may include a “service experience score.” The service experience score may be generated by assigning a numerical value to each event that a network customer experiences. This score may be generated irrespective of whether the customer performed an interaction with the network provider based on the event (for example, called the network provider, submitted a work order through a web portal or mobile device application, etc.). An overall service experience score for the customer may be generated by combining those calculated values over a time period of interest. Measures of variation may then be used to compare customers relative to one another. Additionally, any other types of metrics may also be determined, such as a “customer effort” score, which is described in additional detail below.

In one or more embodiments, the generation of these metrics may be based on actual events that a particular customer is experiencing. The generation of the metrics may also be based on events that are predicted to take place for the customer. In this manner, a metric associated with the customer’s experience may be predicted for the future, and proactive steps to mitigate a low metric may be taken before any of such events occur. Additionally, the one or more metrics may be presented in any format other than a numerical score. For example, the one or more metrics may be presented as a string of text and/or in any other form. That is, the description and depiction of a service experience score as a numerical value herein is not intended to be limiting.

In one or more embodiments, one or more actions may automatically be taken based on any predictions performed using the model. For example, if it is determined that user hardware (such as a modem, for example) is offline or functioning at sub-optimal speeds, one or more test signals may automatically be sent to the hardware, a reboot signal may be sent to the hardware, a firmware update may automatically be performed on the hardware, and/or any other type of automatic actions may be taken by the system without manual operator intervention. Additional examples may include automatic generation of a work order to perform maintenance on a customer’s hardware, re-prioritization of technician schedules, automatic re-routing of network traffic, activation of self-healing/diagnostic sequences in network equipment, directed customers to perform an interaction, etc. These are just a few non-limiting examples of types of automated actions that may be performed, and any other types of actions may also be performed based on the type of event that is predicted.

The systems and methods described herein are advantageous in that they fundamentally change the approach to understanding the customer experience. The systems and methods enhance the understanding of the health of a network, customer satisfaction, and of the source of service impairments. This allows for much more accurate prioritization of issues and better capital investment planning. In particular, the systems and methods may allow for the identification of customers with poor service experience who may not have provided an indication of the poor service experience (for example, they did not perform an interaction with the service provider that would otherwise provide an indication of this poor service experience). In this manner, predictions of customer experience may be performed in advance, even without receiving any interactions or feedback from the particular customer. The same systems and methods may also be used to predict future satisfaction of customers based on any events that are predicted to occur in the future.

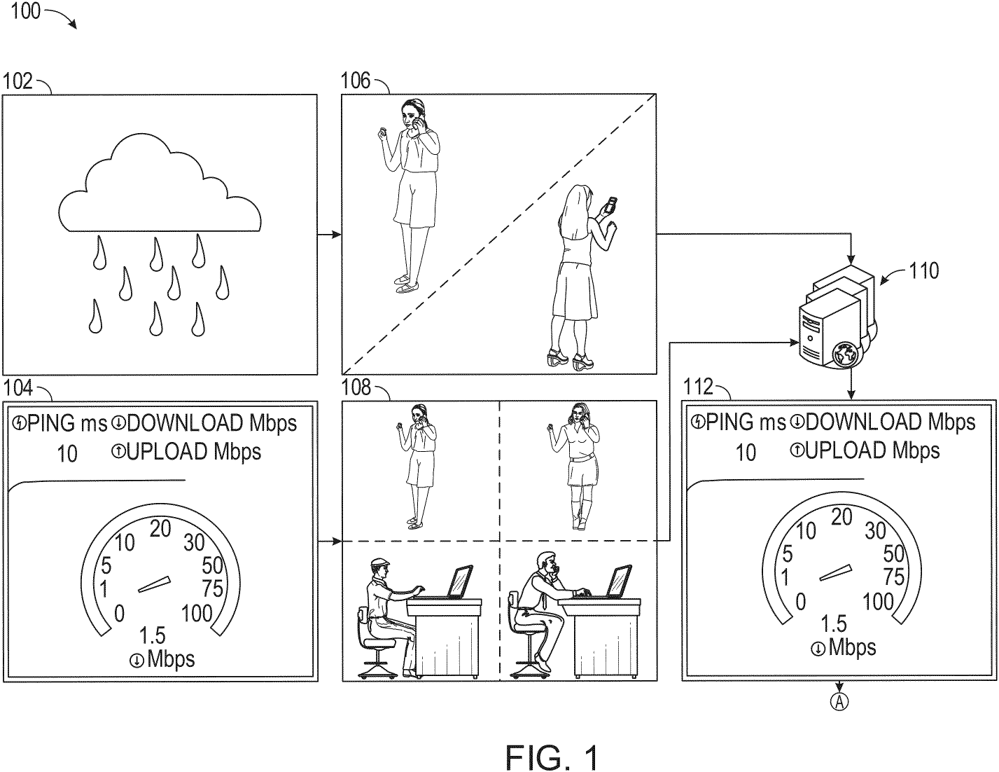

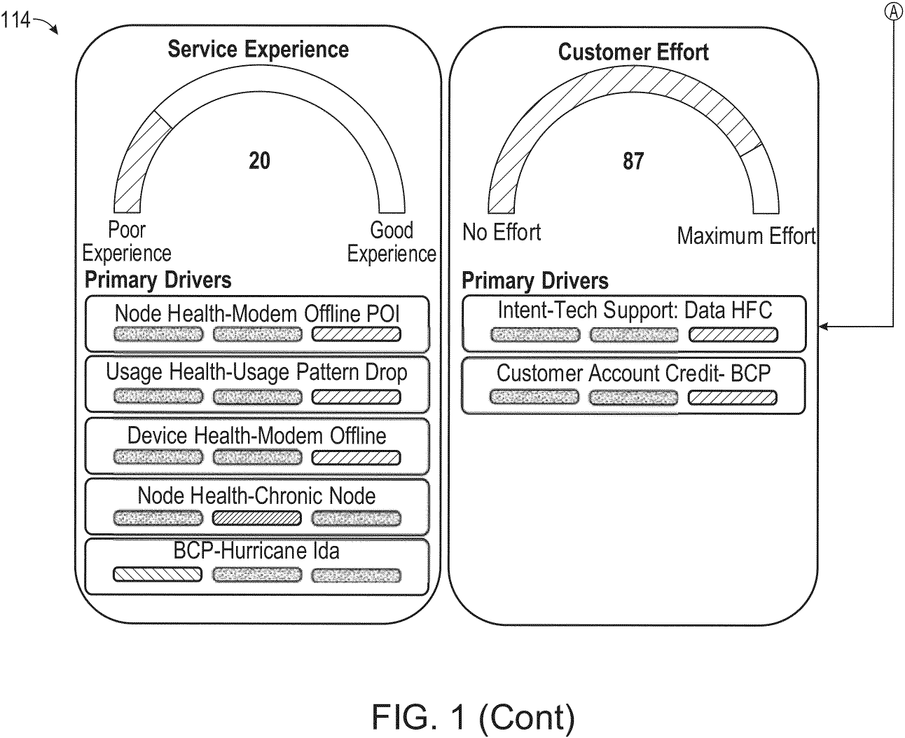

Turning to the figures, FIG. 1 is an example use case 100, in accordance with one or more embodiments of the disclosure. The use case 100 may illustrate an example scenario that may be applicable to the systems and methods described herein. It should be noted that the use case 100 is not intended to be limiting in any way, but is rather merely intended to be a high-level depiction of an example of the implementation of the systems and methods described herein.

In one or more embodiments, the use case 100 may begin with the occurrence of one or more different types of events. For example, the figure illustrates a first event 102 and a second event 104 (however, any other number and/or types of events may also be applicable). The first event 102 may include a weather event that may impact one or more customer’s experience with the network. The second event 104 may include a reduction in a download speed experienced one or more customers when accessing the Internet. Additional details about events, as well as additional examples of different types of events, are described further below.

In one or more embodiments, the use case 100 may next involve identifying one or more interactions based on the first event 102 and the second event 104. In some cases, the interactions may be identified by identifying interactions that may occur during the time period that the events also occur. For example, the figure illustrates two individual customer interactions 106 that take place within the time period during which the first event 102 is occurring. The example interactions 106 may include a customer placing a phone call to the service provider to indicate a problem the customer is experiencing. The interactions 106 may also include a separate customer submitting a troubleshooting ticket via a smartphone application associated with the service provider. Similarly, the figure also illustrates four individual customer interactions that take place within the time period during which the second event 104 is occurring. Two of the interactions 108 may include customers placing a phone call to the service provider, and two of the interactions 108 may include customers submitting a troubleshooting ticket via a web portal associated with the service provider.

Some events, such as the second event 104, may represent a type of event that is experienced by a group of individual customers. For example, while a single equipment offline event may not impact multiple customers, a number of individual customers may experience such an event. Thus, an aggregate of interaction data relating to these individual events may also be collected. Additionally, it should be noted that these interactions (for example, interactions 106 and 108) are merely exemplary, and any other number and/or types of interactions may also be applicable. Further examples of types of interactions are described in additional detail below.

In one or more embodiments, the information obtained relating to the events and the interactions identified during the time periods associated with the events may be provided to one or more models 110 (for example, correlation models, artificial intelligence models, machine learning models, or the like) as inputs This information may be used to train the models 110. The models 110 may then be applied on the individual customer level to predict an individual customer’s experience (which may be quantified through one or more metrics) regardless of whether the customer interacts with the service provider. For example, as illustrated in the figure, an individual customer may be experiencing an event 112, which may also be a reduction in a download speed experienced by the customer. The one or more models 110 may be able to produce one or more metrics indicative of the customer’s probable experience given the event 112 regardless of whether the customer interacts with the service provider based on the event 112. The metrics may also be based on any other types of relevant data, such as historical information associated with the customer. In some cases, the one or more metrics may be presented through a user interface 114 to an operator associated with the service provider. Additional information may also be provided through the user interface 114, such as primary events most heavily weighted with respect to the one or more metrics.

In one or more embodiments, these metrics may then be used to determine actions to take to improve the customer experience. For example, if it is determined that user hardware (such as a modem, for example) is offline or functioning at sub-optimal speeds, one or more test signals may automatically be sent to the hardware, a reboot signal may be sent to the hardware, a firmware update may automatically be performed on the hardware, and/or any other type of automatic actions may be taken by the system without manual operator intervention. Any other actions (which may be automatically performed without requiring human intervention) may also be applicable as well. Additionally, the user interface 114 may not need to necessarily be presented in order for any actions to be automatically taken. For example, the models 110 may determine the one or more metrics, and then automatic action may be taken based on these metrics even before the metrics are presented to an operator. However, in some cases, some or all of the actions may also be manually initiated by an operator as well.

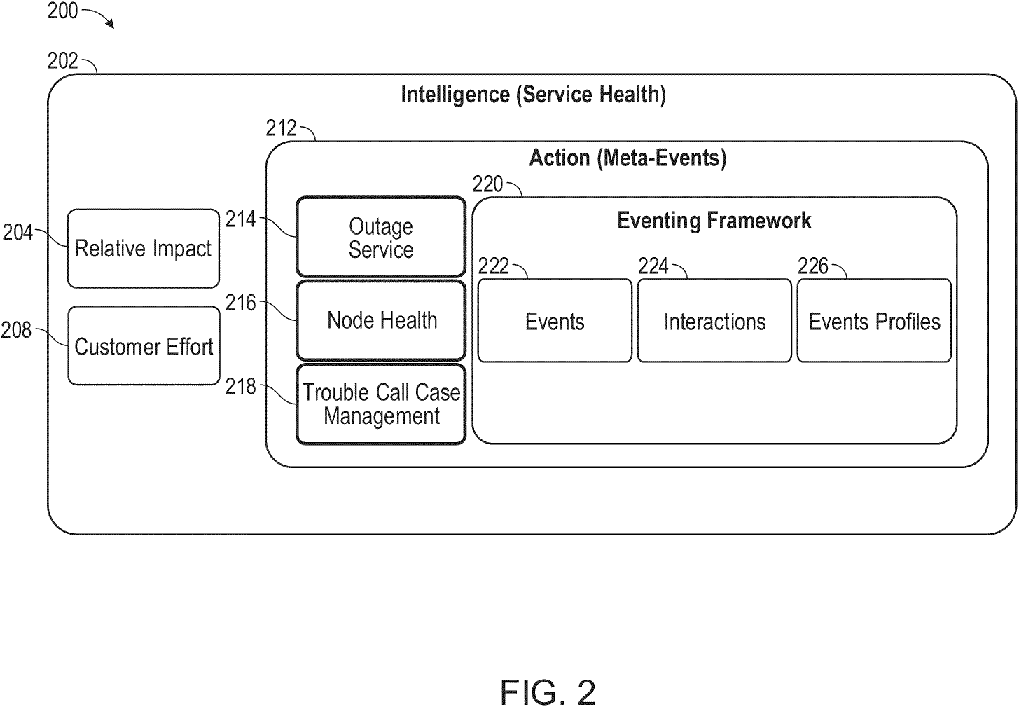

FIG. 2 is an example block diagram 200, in accordance with one or more embodiments of the disclosure.

In one or more embodiments, the block diagram 200 may illustrate different facets that are involved in the systems and methods described herein. The block diagram 200 may include three layers, including at least an intelligence layer 202, an action layer 212, and an event framework layer 220.

In one or more embodiments, the intelligence layer 202 may include the primary outcomes models. These models may sit on top of the framework and may organically scale and grow as new events, interactions, profile measurements, and/or meta-events are added. These models may include any type of model, such as a correlation model, machine learning model, artificial intelligence model, or the like. In this regard, the models may be trained over time based on input data and may be continuously evolving. The intelligence layer 202 may include at least a relative impact block 204 and a customer effort block 208.

In one or more embodiments, the relative impact block 204 may include a model that may quantify one or more customer unique holistic service experiences. For example, the relative impact block 204 may provide an indication of the measurable service experience of the customer. This indication may be determined based on a product of event duration and event magnitude to determine an event impact “area” (for example, an area of a shape formed by an event that occurs for a given duration at a given magnitude as illustrated in plot 300 of FIG. 3). The relative impact block 204 may produce a score for some or all customers across time based on the underlying events they experience. This score can be used to compare unique customer’s relational experiences to each other, or compare, rank, and/or prioritize a grouping of customers as a distribution against similar distributions.

In one or more embodiments, the customer effort block 208 may include a model that may quantify the customer’s unique need for engagement from the system. The customer effort block 208 may provide an indication of an effort level that the customer is putting forth in an attempt to remedy a potential event. This indication may be determined based on a frequency/density model across all measured Interactions (non-limiting examples of interactions are provided with respect to FIG. 5) by the customer, comparative effort density distribution across all customers, unique customer effort vs. distribution. The customer effort block 208 may involve measuring customer experience via direct customer contact rates across various integration channels. The customer effort block 208 may be used in tandem with the relative impact block 204.

In one or more embodiments, the action layer 212 may be the external facing layer of the framework. The action layer 212 may expose events via API and subscription topics to any downstream application that may need to take one or more actions based on any data. The action layer 212 may be associated with meta events, which may consolidate into simple actions and treatments. Meta events leverage common events, interactions, and profiles to create a new decision. A meta event may refer to a model generating a new event from other events in the framework. In this manner, events may not need to be independent models and may use other events as input data to make decisions. Meta events typically simplify overlapping complex events into a consumable action or treatment trigger. These are the models that “flag” or “activate” the various treatment options available when exposed to other systems.

In one or more embodiments, the action layer 212 may include at least an outage service block 214, a node health block 216, and/or a trouble call case management block 218. The outage service block 214, node health block 216, and/or trouble call case management block 218 are merely examples of actions that may be taken by the event framework. Continuing these examples, the outage service block 214 may manage the customer-facing messaging across all channels describing current outage state and restoral times. The node health block 216 may manage the proactive maintenance prioritization of the network, creating work tickets and routing technicians in real-time. The trouble call case management block 218 may retroactively grade scheduled trouble calls against new event detection correlations and may contact customers recommending cancelation for predicted non-actionable work.

In one or more embodiments, event framework layer 220 may be the layer where the primary data environment exists and may be where the bulk of the exploratory analytics are performed. The raw information stored in the event framework layer 220 may not be exposed via external-facing API’s, but may be available in historical and real-time data environments. Much of the data in this layer may also be viewable via user interfaces to facilitate operations and real-time troubleshooting. The event framework layer 220 may follow a simple, standardized data model, relating everything back to customer and time. The event framework layer 220 may include at least event data storage 222, interactions data storage 224, and/or event profiles 226.

In one or more embodiments, the event data storage 222 may be a data layer that may receive and store any data associated with any existing or predicted events. An event may be created via publishing a correctly formatted payload to an SQS feed within the framework, as one non-limiting example. An event may be a data object defined by a grouping of entities that share a common transient or non-transient feature of interest. One non-limiting example of an event 222 may include customer equipment going offline. Additional examples of events 222 may be provided in FIG. 4. The interaction data storage 224 may be a data model that houses all customer interactions across any platforms. The interaction data storage 224 may be designed in a modular way to allow for new interaction types to be added over time. An interaction may be an activity performed by a customer, tool, and/or process. One non-limiting example of an interaction 224 may include a customer generating a work order. Additional examples of interactions 224 may be provided in FIG. 5.

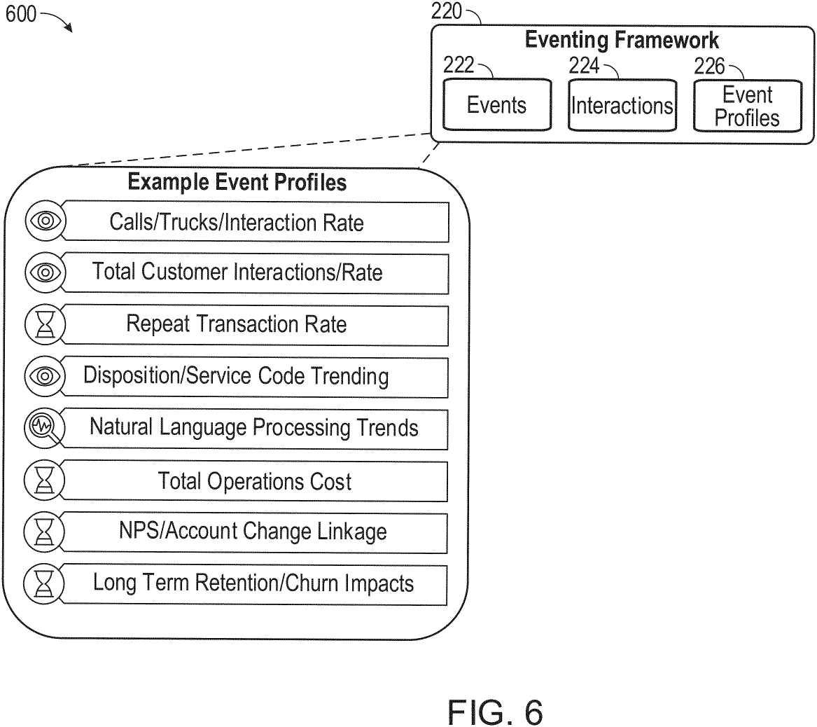

Both of these data stores (the event data storage 222 and the interaction data storage 224) may combine into event profiles 226. Event profiles 226 may be automatic calculations of interactions within and between events that may be stored in a third common data layer. This layer is essentially performing mass computations of metrics across all events, and provides an extremely rich data set on which the secondary models may run (for example, the models at the intelligence layer 202. An event profile 226 may include a metric that is based on a combination of events and interactions. One non-limiting example of an event profile 226 may include an interaction rate for a customer. Additional examples of event profiles 226 may be provided in FIG. 6.

FIG. 3 is an example events plot 300, in accordance with one or more examples of the disclosure.

Particularly, the plot 300 may illustrate a manner in which different types of events (example events are listed in more detail with respect to FIG. 4) are tracked relative to customer actions (for example, “interactions” as described herein) and/or customer time. The plot 300 may represent the tracking of different events for an individual customer, where the magnitudes of the events may be based on previously aggregated data associated with a larger number of customers. For example, the plot 300 may include an x-axis 302 representing a length of time that an event is occurring. The plot 300 may also include a y-axis 304 representing a magnitude of the event. A “magnitude” of an event may be a representation of a correlation established between a number of customer interactions that historically occurred for a particular type of event (example interactions are listed in more detail with respect to FIG. 5). For example, any of the models described herein may be trained according to an aggregate of customer interactions based on any number of occurrences of the specific type of event. Based on the correlation that is then established by the model, a magnitude may be provided to that type of event. This magnitude may then be associated with any events that occur on the individual customer level, as shown in FIG. 3. The plot 300 may illustrate an example of a number of different events occurring for varying amounts of time in an example time frame. For example, the plot 300 illustrates five events occurring within the time frame (a first type of event represented by first event 306, a second type of event represented by second event 308 and third event 310, a third type of event represented by fourth event 312, and a fourth type of event represented by fifth event 314, sixth event 316, and seventh event 318). In this example, the second event 308 and third event 310 may be a same type of event that occurs for two separate time periods within the time frame represented by the plot 300. Additionally, the fifth event 314, sixth event 316, and seventh event 318 may also be a same type of event that occurs for two separate time periods within the time frame represented by the plot 300.

As illustrated in the figure, events may not necessarily occur for the same amount of time and/or may not result in the same number of customer interactions. For example, while the fourth event 312 lasts for a much longer time period than any of the fifth event 314, sixth event 316, and seventh event 318, the individual magnitudes of the fifth event 314, sixth event 316, and seventh event 318 are much greater than the magnitude of the fourth event. This may indicate that the fifth event 314, sixth event 316, and seventh event 318, while much briefer in duration than some of the other types of events, may result in a significantly higher number of customer interactions. As a non-limiting example, the fifth event 314, sixth event 316, and seventh event 318 may represent a temporary network outage, and the fourth event 312 may represent a slight reduction in network bandwidth for one or more customers. Although the network outage may be a brief event, it may also be a more problematic event for customers than a slight reduction in network bandwidth. Thus, the number of interactions for the fifth event 314, sixth event 316, and seventh event 318 may be much greater than the number of interactions for the fourth event 312.

In this manner, the plot 300 may illustrate how a particular customers service experience score (and/or any other metrics representing the experience of the customer) may be generated based on the data produced by the correlation model. That is, the analysis on an individual customer level may not necessarily require the plot to be generated, but rather data relating to the occurrence of any events, magnitudes associated with those events as determined by the correlation model, and the length of such events may simply be used. That is, the plot 300 may simply visually illustrate the application of the correlation model output to an individual customer. However, in some cases, such a plot 300 may be generated and utilized for the analysis at the individual customer level as well.

Additionally, in some cases, any models described herein may involve the use of artificial intelligence, machine learning, or the like. In this manner, the models may also be used to make predictions to allow for future service experience scores (and/or any other metrics) associated with individual customers (or aggregates of customers) to be predicted. These predictions may allow for proactive measures (for example, automatic actions as described herein) to be taken. In some cases, the models may similarly be used to predict future events and base future service experience scores (and/or other metrics) based on these predicted events.

As an example, the relative impact model may be trained using the event profile data in the inner layer of the framework. The relative impact model may develop a mass correlation across all events with all interactions and determine the associated magnitude (or “weight”) of each event type. This model may grow and/or retrains automatically as new events are added to the framework over time.

The models may also be more granular in any predictions that are made. For example, during the initial training process (and/or during real-time training mentioned below), a model may be trained using data representative of an aggregate of customers. Once a model is initially trained, however, it may then be applied on a more granular level to make more specific types of predictions that may not necessarily represent the aggregate of customers. For example, the model may make such predictions with respect to a particular sub-set of customers, which may be selected based on any number of factors, such as geographic location, type of service, type of equipment being used, demographic information, and/or any other types of factors. Predictions may also be made at the individual customer level. That is, the model may be used to perform predictions for an individual customer to mitigate or prevent future events that may occur that specifically impact the single customer.

These specific types of predictions may be automatically determined and/or may be manually indicated by a user. As one non-limiting example, an operator viewing data produced by the model may indicate that they wish to filter data based on customers operating on a certain firmware version. As a second non-limiting example, the user may indicate that they wish to filter data to represent customers in a specific geographical region. The data may also be filtered in any number of other ways as well.

In one or more embodiments, one or more actions may automatically be taken based on any predictions performed using the model. For example, if it is determined that user hardware (such as a modem, for example) is offline or functioning at sub-optimal speeds, one or more test signals may automatically be sent to the hardware, a reboot signal may be sent to the hardware, a firmware update may automatically be performed on the hardware, and/or any other type of automatic actions may be taken by the system without manual operator intervention. Additional examples may include automatic generation of a work order to perform maintenance on a customer’s hardware, re-prioritization of technician schedules, etc. These are just a few non-limiting examples of types of automated actions that may be performed, and any other types of actions may also be performed based on the type of event that is predicted.

Additionally, the models may also be trained in real-time as well. That is, the model may not necessarily be trained with an initial data set and then produce any future predictions based only on that set of training data. The models may continue to use any additional data obtained in real-time to further refine the model to produce more effective predictions. This real-time training may be used to adjust the correlations for any types of events that may become less impactful or more impactful over time.

FIG. 4 is an example listing of types of events that may be included within the events data storage 222, in accordance with one or more examples of the disclosure.

In one or more embodiments, an event may be a data object defined by a grouping of entities that share a common transient or non-transient feature of interest. That is, an event may be an occurrence that results in a change to a customer’s service experience. Events may also be any other type of occurrence that may indicate a change in a customer’s service experience. In some cases, such events may often be accompanied by a customer interaction (for example, a customer contacting the network service provider through telephone, a web portal, a mobile device application, etc.). A non-limiting list of different types of events is provided in the figure. For example, an event may include a hardware-based problem, such as a modem going offline, an increased network latency, a hybrid fiber-coaxial (HFC) upstream signal-to-noise ratio (SNR) change, an interface congestion, an upcoming planned maintenance, a current maintenance, a current customer network usage amount, a future customer network usage amount, and/or any other types of events. While this list provides some examples of different types of events that may be applicable to the systems and methods described herein, the list is not intended to be limiting, and any other types of events may also be applicable.

In one or more embodiments, the systems and methods described herein may layer all distinct events of interest over top of the customers and time. The core data model ensures all data elements added (for example, events, and interactions) map to distinct customer account numbers and timestamps. This “large flat” format is simple in design but complicated to manage as it sources data from dozens of distinct platforms and models. Modular ingestion of events and interactions assists in developing such a model. Once developed, however, it dramatically reduces tribal knowledge requirements and provides a singular location for configuration and quality management. Thus, a simple scalable data model is used that allows for immediate analytics re-use and exploration. This should dramatically reduce time to onboard analysts and simplify configuration management. Events can be activated in real-time, batch loaded, or even placed as future predictions.

FIG. 5 is an example listing of types of interactions that may be included in the interactions data storage 224, in accordance with one or more examples of the disclosure.

In one or more embodiments, an interaction may be an activity performed by a customer, tool, and/or process. For example, when a customer is experiencing a reduction in network upload speeds, the customer may contact a network service provider to diagnose the reduction in speed. A network service provider, for example, may include an entity controlling the network (for example, a cable network) as described herein and providing service to the customers. This action of the customer initiating the contact may be considered an interaction. A non-limiting list of different types of interactions is provided in the figure. For example, an interaction may include a customer interactive voice response (IVR) exit point, a solution center intent, a work order status, a customer chat box transcript, a survey, a customer credit, an account upgrade and/or downgrade, a customer device error code, an executive escalation, an issue ticket, etc. Interactions may be performed through any number of different types of systems. For example, a customer may contact the service provider by telephone, through a web portal, and/or using a mobile device application. While this list provides some examples of different types of interactions that may be applicable to the systems and methods described herein, the list is not intended to be limiting, and any other types of interactions may also be applicable.

FIG. 6 is an example listing of types of event profiles 226, in accordance with one or more examples of the disclosure.

In one or more embodiments, an event profile 226 may include a metric that is based on a combination of events and interactions. Event profiles 226 may calculate reusable measurements of interest on all events that take place in the event framework 200. Event profiles 226 may provide dramatic scaling enhancement to analytics exploration; it no longer may be necessary to build models to each data point.

A non-limiting list of different types of event profiles is provided in the figure. For example, an event profile may include a number of calls, trucks, interaction rate, a total customer interaction rate, a repeat transaction rate, a disposition or service coding trending, a natural language processing trend, a total operations cost, an account change linkage, a long term retention. While this list provides some examples of different types of event profiles that may be applicable to the systems and methods described herein, the list is not intended to be limiting, and any other types of event profiles may also be applicable.

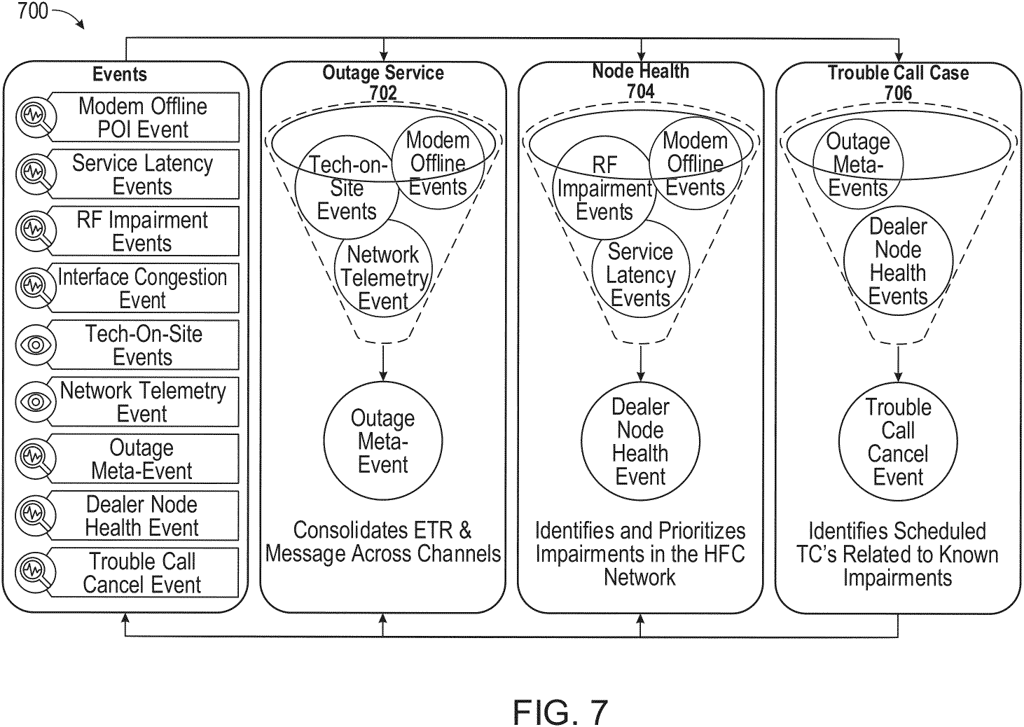

FIG. 7 is an example representation 700 of the action layer (for example, action layer 212 described with respect to FIG. 2), in accordance with one or more examples of the disclosure. That is, FIG. 7 may exemplify how actions may be activated based on different types of events. These are merely examples of actions that may be initiated by the event framework. For example, the outage model 702 may manage the customer-facing messaging across all channels describing current outage state and restoral times. The node health model 704 may manage the proactive maintenance prioritization of our HFC network, creating work tickets and routing technicians in real-time. The trouble call case management model 706 may retroactively grade scheduled trouble calls against new event detection correlations, and contacts customers recommending cancelation for predicted non-actionable work.

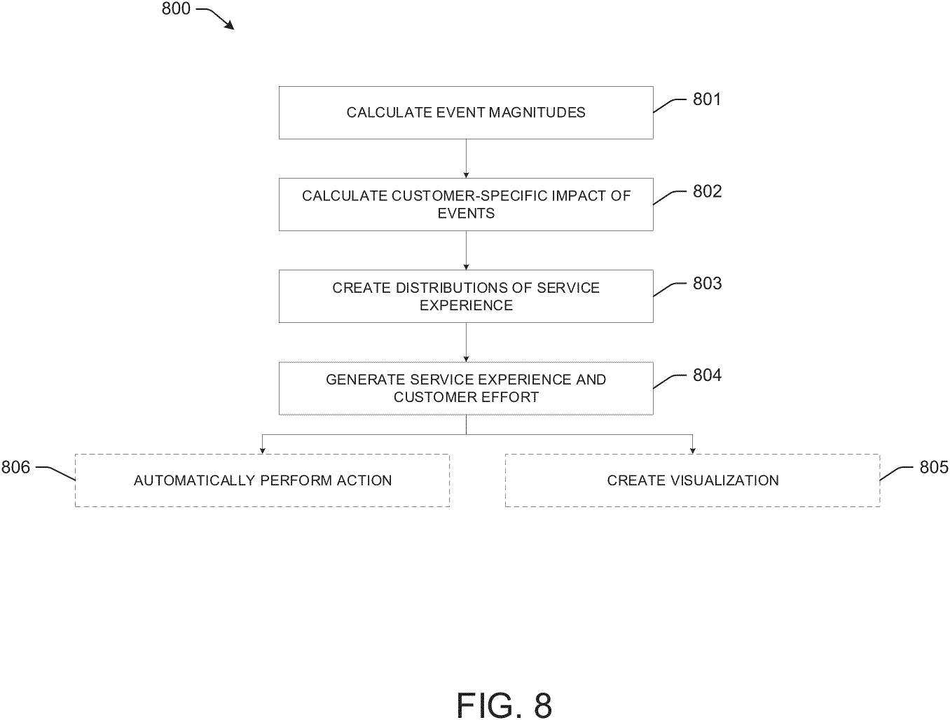

FIG. 8 is an example flow diagram, in accordance with one or more examples of the disclosure.

At block 801, computer-executable instructions stored on a memory of a device, such as a computing device, may be executed to calculate event magnitudes. Calculating event magnitudes may involve applying a mass correlation model to an aggregate of events and interactions in the framework. The model output may indicate how each event type (in aggregate) relates to interactions (in aggregate) as a ratio. For example, an event magnitude of two may indicate that the event generally over-indexes on customer interactions by twice the amount when compared to a random sample of time.

At block 802, computer-executable instructions stored on a memory of a device, such as a computing device, may be executed to calculate customer-specific event impacts. Calculating customer-specific event impacts may involve applying the magnitude calculations determined at block 801 back to individual customers and generating the impact to the service experience of the customer over time. An example of this application is illustrated in FIG. 3, as aforementioned.

At block 803, computer-executable instructions stored on a memory of a device, such as a computing device, may be executed to create distributions of service experiences. The distribution of service experiences may involve taking metrics associated with individual customers and aggregating the individual metrics based on any automatically-defined or user-defined groupings (for example, individual customer metrics may be grouped based on location, service type, demographics, etc. to gain an understanding of metrics associated with particular groupings of customers and/or make decisions (automatically or manually) on actions that should be taken to remedy situations occurring with large groups of customers). Creating the distributions may thus involve determining one or more groupings, determining customers that fall within the one or more groupings, and aggregating any metrics associated with those customers.

At block 804, computer-executable instructions stored on a memory of a device, such as a computing device, may be executed to generate service experience and customer effort metrics.

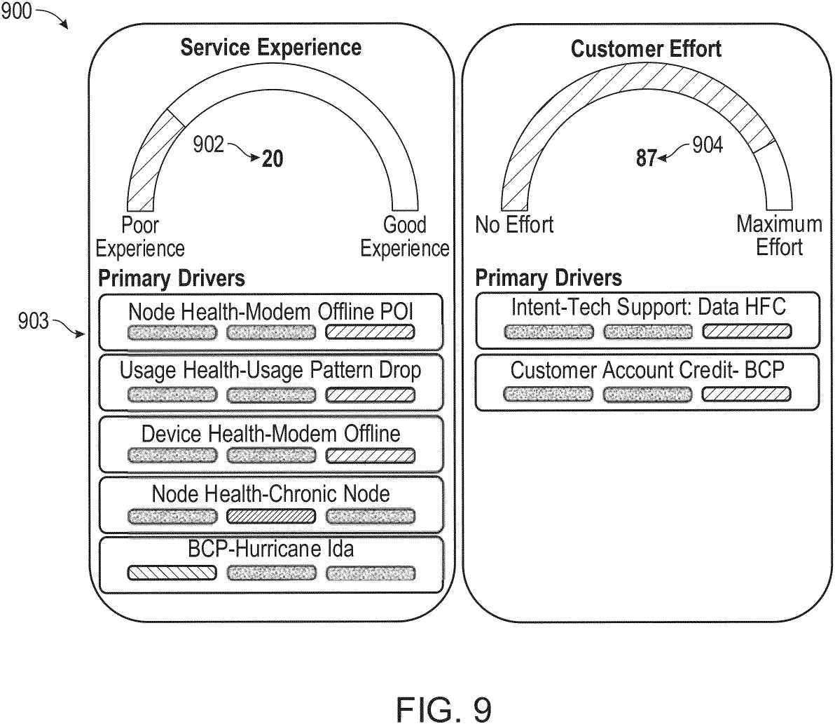

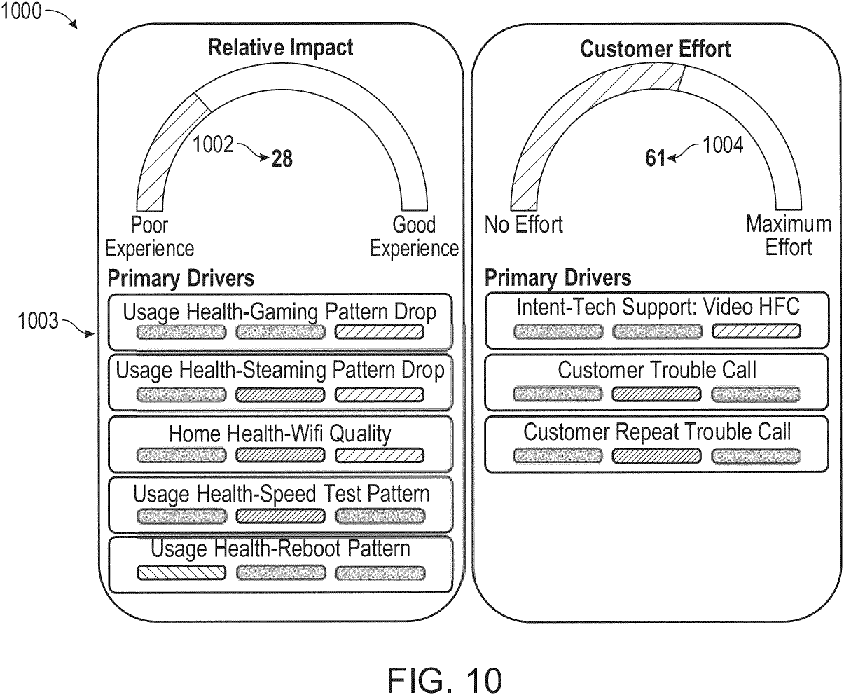

At optional block 805, computer-executable instructions stored on a memory of a device, such as a computing device, may be executed to create a visualization. For example, a visualization such as the user interfaces depicted in FIGS. 9-10 may be created. However, these user interfaces are just two examples of visualizations, and the visualizations may be presented in any other format. As a first example, visualizations may be generated for historical timelines of specific customers/groups of customers. As a second example, visualizations may be generated to compare specific time segments of customers/groups of customers. As a third example, visualizations may be generated to show primary components of service experience scores based on event contribution. Any other types of visualizations may also be generated and presented.

At optional block 806, computer-executable instructions stored on a memory of a device, such as a computing device, may be executed to automatically perform an action. In some cases, performing an action may involve creating an event in the event framework, defining where and when specific action is to be taken, and necessary data elements. Performing the action may also involve delivering the new action event trigger into downstream applications via the action layer of event framework. However, performing the action may be initiated in any other manner as well. For example, if it is determined that user hardware (such as a modem, for example) is offline or functioning at sub-optimal speeds, one or more test signals may automatically be sent to the hardware, a reboot signal may be sent to the hardware, a firmware update may automatically be performed on the hardware, and/or any other type of automatic actions may be taken by the system without manual operator intervention. Additional examples may include automatic generation of a work order to perform maintenance on a customer’s hardware, re-prioritization of technician schedules, automatic re-routing of network traffic, activation of self-healing/diagnostic sequences in network equipment, directed customers to perform an interaction, etc. These are just a few non-limiting examples of types of automated actions that may be performed and any other types of actions may also be performed based on the type of event that is predicted.

FIG. 9 is an example visualization of one or more metrics, in accordance with one or more examples of the disclosure.

In one or more embodiments, the visualization may be in the form of a user interface 900 that may present information to a user. For example, the user interface 900 may present a service experience score 902 that is associated with the particular user. The service experience score may include an overall metric that is determined based on the application of the models to the particular customer. It should be noted that although the service experience score 902 is presented as a numerical value, the service experience score 902 may be presented in any other format as well (for example, a percentage, a text string, etc.).

In one or more embodiments, the user interface 900 may also present any other types of information. For example, the user interface 900 may present primary drivers 903 that are resulting in the particular service experience score 902. A primary driver may include an event associated with the customer that may have a more significant impact on the service experience score 902 than other events. For example, the service experience score 902 illustrated in the figure has primary drivers of modem offline events, network usage pattern changes, a chronic node (for example, an area of a network with an identified recurring and/or intermittent issue under an active triage), and a weather event in an area associated with the customer. The user interface 900 may also present an indication of a level of impact that a particular event may have on the service experience score 902. For example, the figure indicates that the modem offline event(s) and usage pattern drop have a greater impact on the service experience score 902 than the chronic node and the weather event. These are merely examples of different types of events that may drive a particular service experience score 902, and any other events may also be applicable (for example, such as any events described with respect to FIG. 4 and/or any other events).

In some cases, drivers may be ranked based on contribution of underlying events to the overall score for that customer or group of customers. Events with higher contributions to the score may be more impactful. Other events shown can be informative, but not specifically derived from service experience. These may include informational events that the business would manage, such as known severe weather damage, known issues/bugs in a firmware, or other such information that could provide relevant context to the service experience. These may not be factored into the score itself. These informative events may still exist within the event framework, but may be largely used to display to the business via user interfaces.

In one or more embodiments, the user interface 900 may also present another example of a customer effort score 904 that is based on different primary drivers. For example, the customer effort score 904 illustrated in the figure has primary drivers of technical support and a customer account credit. These are merely examples of different types of interactions that may drive a particular service experience score 902, and any other interactions may also be applicable.

Although the figure only shows a service experience score 902 and a customer effort score 904, the user interface 900 may present any other number of metrics associated with any other models and/or any other types of information as well. Additionally, the user interface 900 may present any other type of information. This information may be automatically determined by the system and/or manually configured by a user interacting with the user interface 900. For example, a user may indicate that they desire to view all events leadings to a particular service experience score 902 rather than just being presented with the primary drivers 903.

The user interface 900 (and/or any other user interface described herein or otherwise) may assist in visualizing all of the information associated with the event framework 200 down to the individual customer level, including the relative impact and customer effort scores. Scores may be viewed for a single individual customer, which may provide insight into the service experience of the customer without ever having to interact with the customer. The scores may also be an indicator of scenarios where actions need to be taken to mitigate current poor customer experience and/or predicted future experience.

FIG. 10 is an example visualization of one or more metrics, in accordance with one or more examples of the disclosure.

In one or more embodiments, the visualization may be in the form of a user interface 1000 that may present information to a user. For example, the user interface 1000 may present a relative impact score 1002 that is associated with the particular user. The relative impact score 1002 may include a metric that is determined based on the application of the relative impact model to the particular customer. It should be noted that although the relative impact score 1002 is presented as a numerical value, the relative impact score 1002 may be presented in any other format as well (for example, a percentage, a text string, etc.).

In one or more embodiments, the user interface 1000 may also present any other types of information. For example, the user interface 1000 may present primary drivers 1003 that are resulting in the particular relative impact score 1002. For example, the relative impact score 1002 illustrated in the figure has primary drivers of a gaming pattern drop, a streaming pattern drop, a WiFi quality, a speed test pattern, a reboot pattern. These are merely examples of different types of events that may drive a particular relative impact score 1002, and any other events may also be applicable (for example, such as any events described with respect to FIG. 4 and/or any other events).

In one or more embodiments, any of the user interfaces may provide a comprehensive visualization of any relevant information. The user interfaces may provide any aggregation of customers and may be used to identify if there are concerns with impact or effort. This view provides a common lens into the experience of essentially any part of our business, and can provide a simple comparative bar between them. As non-limiting examples, the user interfaces may also be information to be viewed about nodes, a CMTS, headends, network topology, device types, firmware versions, vendors, service tiers, bundles, product offerings, all new customers in a period of time, only customers with repeat trouble calls, and/or any other types of information.

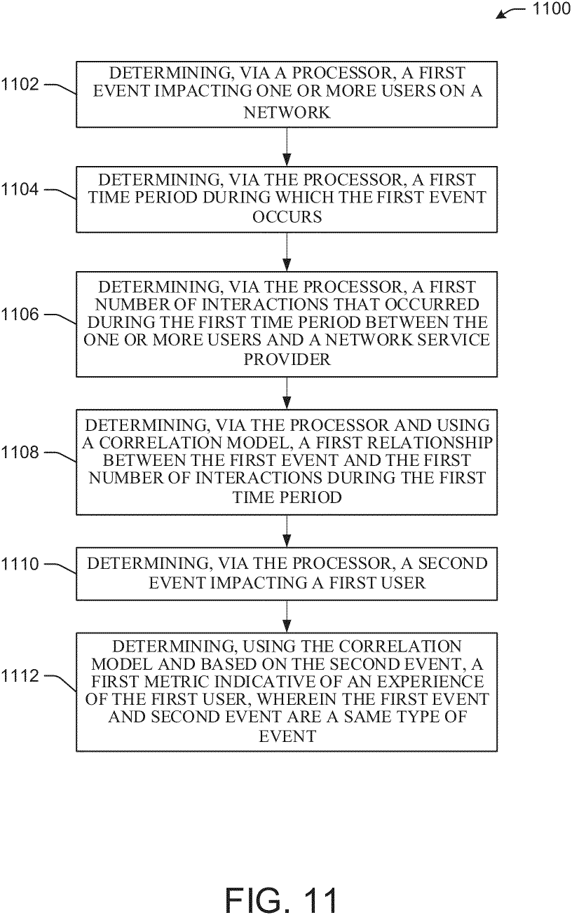

FIG. 11 is an example method 1100, in accordance with one or more embodiments of the disclosure.

In one or more embodiments, FIG. 11 illustrates a method 1100 that may be performed by a system or device (such as machine 1200, for example).

At block 1102, the method 1100 may include determining, via a processor, a first event impacting one or more users on a network. At block 1104, the method 1100 may include determining, via the processor, a first time period during which the first event occurs. At block 1106, the method 1100 may include determining, via the processor, a first number of interactions that occurred during the first time period between the one or more users and a network service provider. At block 1108, the method 1100 may include determining, via the processor and using a correlation model, a first relationship between the first event and the first number of interactions during the first time period. At block 1110, the method 1100 may include determining, via the processor, a second event impacting a first user. At block 1112, the method 1100 may include determining, using the machine learning model, and based on the second event, a first metric indicative of an experience of the first user, wherein the first event and second event are a same type of event.

In one or more embodiments, the method 1100 may also include automatically performing, via the processor, an action to remedy the second event prior to an interaction between the first user and the network service provider.

In one or more embodiments, the method 1100 may also include determining, via a processor, a third event associated with the network, where the third event is a different type of event than the first event. The method 1100 may also include determining, via the processor, a second time period during which the third event occurs. The method 1100 may also include determining, via the processor, a third number of interactions that occurred during the second time period. The method 1100 may also include determining, via the processor, a second relationship between the third event and the third number of interactions during the second time period. The method 1100 may also include training the correlation model based on the second relationship.

In one or more embodiments, the one or more users include an aggregate of users.

In one or more embodiments, the correlation model includes a machine learning model, and wherein the method further comprises determining, using the machine learning model and based on a predicted future event, a predicted second metric indicative of a future experience of the first user.

In one or more embodiments, the method 1100 may also include determining a second metric indicative of a customer effort in initiating one or more interactions.

In one or more embodiments, the method 1100 further includes causing to present a user interface including the first metric.

One or more operations of the methods, process flows, or use cases of FIGS. 1-11 may have been described above as being performed by a user device, or more specifically, by one or more program module(s), applications, or the like executing on a device. It should be appreciated, however, that any of the operations of the methods, process flows, or use cases of FIGS. 1-11 may be performed, at least in part, in a distributed manner by one or more other devices, or more specifically, by one or more program module(s), applications, or the like executing on such devices. In addition, it should be appreciated that processing performed in response to execution of computer-executable instructions provided as part of an application, program module, or the like may be interchangeably described herein as being performed by the application or the program module itself or by a device on which the application, program module, or the like is executing. While the operations of the methods, process flows, or use cases of FIGS. 1-11 may be described in the context of the illustrative devices, it should be appreciated that such operations may be implemented in connection with numerous other device configurations.

The operations described and depicted in the illustrative methods, process flows, and use cases of FIGS. 1-11 may be carried out or performed in any suitable order, such as the depicted orders, as desired in various example embodiments of the disclosure. Additionally, in certain example embodiments, at least a portion of the operations may be carried out in parallel. Furthermore, in certain example embodiments, less, more, or different operations than those depicted in FIGS. 1-11 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

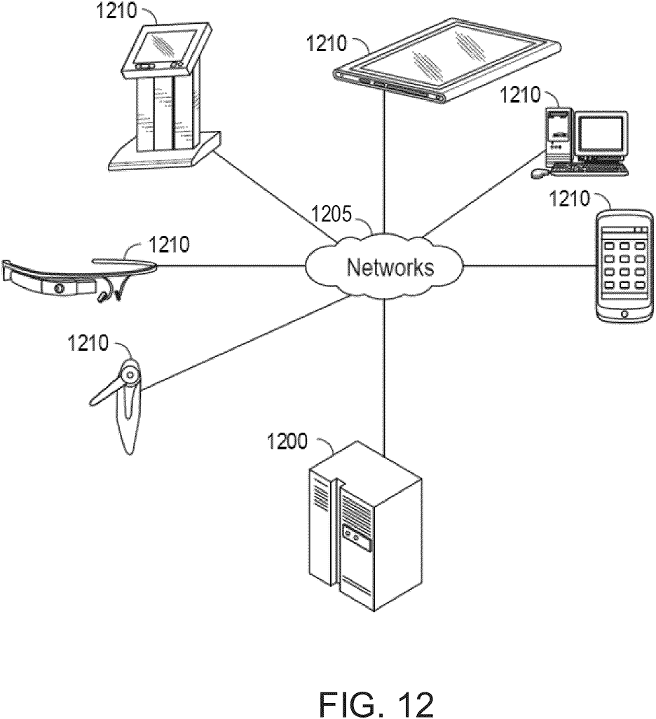

FIG. 12 is an example system, in accordance with one or more embodiments of the disclosure.

As is shown in FIG. 12, this particular embodiment may include one or more management computing entities 1200, one or more networks 1205, and one or more user devices 1210. Each one of these components, entities, devices, systems, and similar words used herein interchangeably may be in direct or indirect communication with, for example, one another over the same or different wired or wireless networks. Additionally, while FIG. 12 illustrates the various system entities as separate, standalone entities, the various embodiments are not limited to this particular architecture.

In various aspects, the management computing entities 1200 may include various devices or portions of devices on a cable network, including cable modems, optical nodes, ta s, active taps, switches, medium access control (MAC) devices, physical layer (PHY) devices, amplifiers, fiber nodes, access points (APs), and the like, variously described below. In another embodiment, such devices may include circuitry (e.g., processors and memory) and associated software instructions (e.g., computer code) to perform various functions associated with such devices (e.g., determine signals for transmission, modulate signals in accordance with one or more modulation techniques, transmit signals including packets, receive including packets, process including packets, schedule including packets, etc.). Moreover, such management computing entities 1200 may perform aspects of the transmission of data over networks in accordance with various techniques as described herein.

In another embodiment, the network(s) 1205 may include, but not be limited to, cable networks, including hybrid fiber-coaxial networks. More broadly, the network(s) 1205 may include at least portions of wireless networks or wired networks. In another embodiment, a cable network may use various sub-networks (e.g., WiFi networks, cellular networks) to perform aspects of the functionality described herein, for example, in connection with the disclosed devices (e.g., switches, taps, active taps, MAC devices, cable modem termination system (CMTS) devices, PHY devices, amplifiers, optical fiber nodes, access points and the like). In another embodiment, the networks 1205 may use at least a portion of a fifth-generation cellular mobile communications, also referred to as 5G herein.

In another embodiment, the user devices 1210 can include devices associated with a customer premises equipment (e.g., devices located in a dwelling of a user or on the person of a user). Non-limiting examples may include one or more computers, computing entities, desktop computers, mobile phones, tablets, phablets, notebooks, laptops, distributed systems, gaming consoles (for example, Xbox, Play Station, Wii), watches, glasses, iBeacons, proximity beacons, key fobs, radio frequency identification (RFID) tags, ear pieces, scanners, televisions, dongles, cameras, wristbands, wearable items/devices, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein.

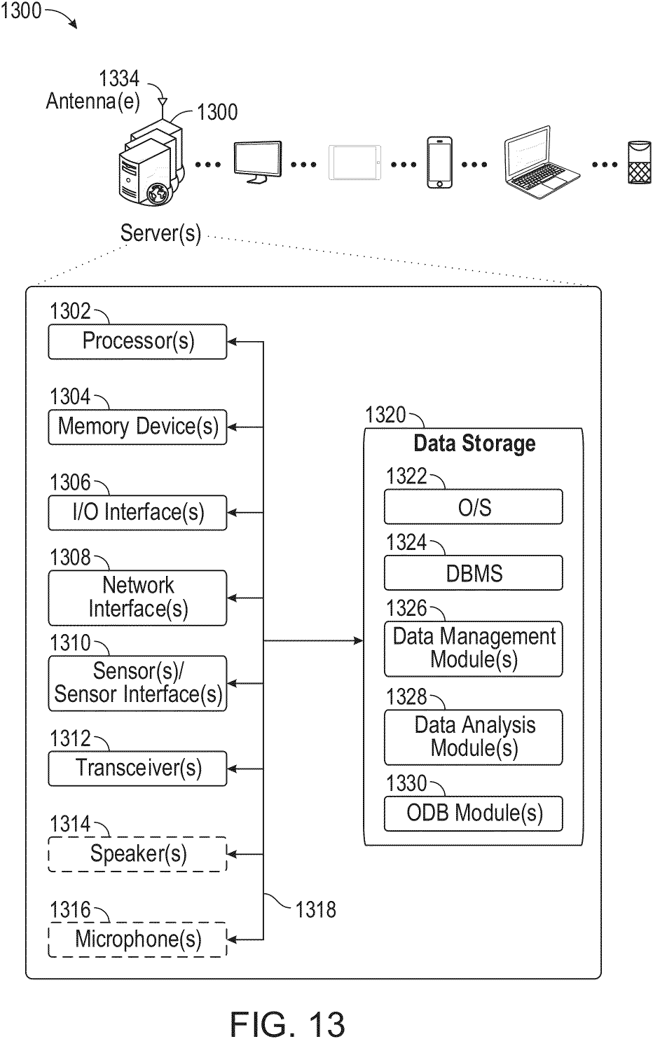

FIG. 13 is a schematic block diagram of one or more illustrative server(s) 1300 in accordance with one or more example embodiments of the disclosure. The server(s) 1300 may include any suitable computing device including, but not limited to, a server system, a mobile device such as a smartphone, a tablet, an e-reader, a wearable device, or the like; a desktop computer; a laptop computer; a content streaming device; a set-top box; or the like. The server(s) 1300 may correspond to an illustrative device configuration for the content selection servers of FIGS. 1-12.

The server(s) 1300 may be configured to communicate via one or more networks with one or more servers, user devices, or the like. The server(s) 1300 may be configured to receive data from one or more onboard diagnostic tools, analyze the data, provide the data via an interface to one or more entities, and/or generate alerts based on the data and predetermined rules.

The server(s) 1300 may be configured to communicate via one or more networks. Such network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the server(s) 1300 may include one or more processors (processor(s)) 1302, one or more memory devices 1304 (generically referred to herein as memory 1304), one or more input/output (I/O) interfaces 1306, one or more network interfaces 1308, one or more sensors or sensor interfaces 1310, one or more transceivers 1312, one or more optional speakers 1314, one or more optional microphones 1316, and data storage 1320. The server(s) 1300 may further include one or more buses 1318 that functionally couple various components of the server(s) 1300. The server(s) 1300 may further include one or more antenna(e) 1334 that may include, without limitation, a cellular antenna for transmitting or receiving signals to/from a cellular network infrastructure, an antenna for transmitting or receiving WiFi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth. These various components will be described in more detail hereinafter.

The bus(es) 1318 may include at least one of a system bus, a memory bus, an address bus, or a message bus, and may permit the exchange of information (e.g., data (including computer-executable code), signaling, etc.) between various components of the server(s) 1300. The bus(es) 1318 may include, without limitation, a memory bus or a memory controller, a peripheral bus, an accelerated graphics port, and so forth. The bus(es) 1318 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnect (PCI) architecture, a PCI-Express architecture, a Personal Computer Memory Card International Association (PCMCIA) architecture, a Universal Serial Bus (USB) architecture, and so forth.

The memory 1304 of the server(s) 1300 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 1304 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 1304 may include main memory as well as various forms of cache memory such as instruction cache(s), data cache(s), translation lookaside buffer(s) (TLBs), and so forth. Further, cache memory such as a data cache may be a multilevel cache organized as a hierarchy of one or more cache levels (L1, L2, etc.).

The data storage 1320 may include removable storage and/or non-removable storage, including, but not limited to, magnetic storage, optical disk storage, and/or tape storage. The data storage 1320 may provide non-volatile storage of computer-executable instructions and other data. The memory 1304 and the data storage 1320, removable and/or non-removable, are examples of computer-readable storage media (CRSM) as that term is used herein.

The data storage 1320 may store computer-executable code, instructions, or the like that may be loadable into the memory 1304 and executable by the processor(s) 1302 to cause the processor(s) 1302 to perform or initiate various operations. The data storage 1320 may additionally store data that may be copied to the memory 1304 for use by the processor(s) 1302 during the execution of the computer-executable instructions. Moreover, output data generated as a result of execution of the computer-executable instructions by the processor(s) 1302 may be stored initially in the memory 1304, and may ultimately be copied to the data storage 1320 for non-volatile storage.

More specifically, the data storage 1320 may store one or more operating systems (O/S) 1322; one or more database management systems (DBMSs) 1324; and one or more program module(s), applications, engines, computer-executable code, scripts, or the like such as, for example, one or more data management module(s) 1326, one or more data analysis module(s) 1328, and/or one or more OBD module(s) 1330. Some or all of these module(s) may be sub-module(s). Any of the components depicted as being stored in the data storage 1320 may include any combination of software, firmware, and/or hardware. The software and/or firmware may include computer-executable code, instructions, or the like that may be loaded into the memory 1304 for execution by one or more of the processor(s) 1302. Any of the components depicted as being stored in the data storage 1320 may support functionality described in reference to corresponding components named earlier in this disclosure.

The data storage 1320 may further store various types of data utilized by the components of the server(s) 1300. Any data stored in the data storage 1320 may be loaded into the memory 1304 for use by the processor(s) 1302 in executing computer-executable code. In addition, any data depicted as being stored in the data storage 1320 may potentially be stored in one or more datastore(s) and may be accessed via the DBMS 1324 and loaded in the memory 1304 for use by the processor(s) 1302 in executing computer-executable code. The datastore(s) may include, but are not limited to, databases (e.g., relational, object-oriented, etc.), file systems, flat files, distributed datastores in which data is stored on more than one node of a computer network, peer-to-peer network datastores, or the like. In FIG. 13, an example datastore(s) may include, for example, web content, advertisement campaigns, advertisements, content items, and/or other information.

The processor(s) 1302 may be configured to access the memory 1304 and execute the computer-executable instructions loaded therein. For example, the processor(s) 1302 may be configured to execute the computer-executable instructions of the various program module(s), applications, engines, or the like of the server(s) 1300 to cause or facilitate various operations to be performed in accordance with one or more embodiments of the disclosure. The processor(s) 1302 may include any suitable processing unit capable of accepting data as input, processing the input data in accordance with stored computer-executable instructions, and generating output data. The processor(s) 1302 may include any type of suitable processing unit including, but not limited to, a central processing unit, a microprocessor, a reduced instruction set computer (RISC) microprocessor, a complex instruction set computer (CISC) microprocessor, a microcontroller, an application-specific integrated circuit (ASIC), a field-programmable gate array (FPGA), a system-on-a-chip (SoC), a digital signal processor (DSP), and so forth. Further, the processor(s) 1302 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 1302 may be capable of supporting any of a variety of instruction sets.

Referring now to functionality supported by the various program module(s) depicted in FIG. 13, the data management module(s) 1326 may include computer-executable instructions, code, or the like that responsive to execution by one or more of the processor(s) 1302 may perform functions including, but not limited to, receiving and transmitting data to OBD tools, asset management personnel, management entities, financial entities, and the like.

The data analysis module(s) 1328 may include computer-executable instructions, code, or the like that are responsive to execution by one or more of the processor(s) 1302 may perform functions including, but not limited to, translating and analyzing data received from OBD tools and other sources. The data may be analyzed using machine-learning techniques and other data analysis mechanisms that may provide insight into the data obtained from the OBD tools.

The OBD module(s) 1330 may include computer-executable instructions, code, or the like that responsive to execution by one or more of the processor(s) 1302 may perform functions including, but not limited to, communicating with OBD tools, transmitting instructions, and managing firmware updates for the OBD tools.

Referring now to other illustrative components depicted as being stored in the data storage 1320, the O/S 1322 may be loaded from the data storage 1320 into the memory 1304 and may provide an interface between other application software executing on the server(s) 1300 and the hardware resources of the server(s) 1300. More specifically, the O/S 1322 may include a set of computer-executable instructions for managing hardware resources of the server(s) 1300 and for providing common services to other application programs (e.g., managing memory allocation among various application programs). In certain example embodiments, the O/S 1322 may control execution of the other program module(s) to dynamically enhance characters for content rendering. The O/S 1322 may include any operating system now known or which may be developed in the future, including, but not limited to, any server operating system, any mainframe operating system, or any other proprietary or non-proprietary operating system.

The DBMS 1324 may be loaded into the memory 1304 and may support functionality for accessing, retrieving, storing, and/or manipulating data stored in the memory 1304 and/or data stored in the data storage 1320. The DBMS 1324 may use any of a variety of database models (e.g., relational model, object model, etc.) and may support any of a variety of query languages. The DBMS 1324 may access data represented in one or more data schemas and stored in any suitable data repository including, but not limited to, databases (e.g., relational, object-oriented, etc.), file systems, flat files, distributed datastores in which data is stored on more than one node of a computer network, peer-to-peer network datastores, or the like. In those example embodiments in which the server(s) 1300 is a mobile device, the DBMS 1324 may be any suitable lightweight DBMS optimized for performance on a mobile device.

Referring now to other illustrative components of the server(s) 1300, the input/output (I/O) interface(s) 1306 may facilitate the receipt of input information by the server(s) 1300 from one or more I/O devices as well as the output of information from the server(s) 1300 to one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the server(s) 1300 or may be separate. The I/O devices may further include, for example, any number of peripheral devices such as data storage devices, printing devices, and so forth.

The I/O interface(s) 1306 may also include an interface for an external peripheral device connection such as a universal serial bus (USB), FireWire, Thunderbolt, Ethernet port or other connection protocol that may connect to one or more networks. The I/O interface(s) 1306 may also include a connection to one or more of the antenna(e) 1334 to connect to one or more networks via a wireless local area network (WLAN) (such as WiFi) radio, Bluetooth, ZigBee, and/or a wireless network radio, such as a radio capable of communication with a wireless communication network such as a Long Term Evolution (LTE) network, WiMAX network, 3G network, etc.

The server(s) 1300 may further include one or more network interface(s) 1308 via which the server(s) 1300 may communicate with any of a variety of other systems, platforms, networks, devices, and so forth. The network interface(s) 1308 may enable communication, for example, with one or more wireless routers, one or more host servers, one or more web servers, and the like via one or more networks.

The antenna(e) 1334 may include any suitable type of antenna depending, for example, on the communications protocols used to transmit or receive signals via the antenna(e) 1334. Non-limiting examples of suitable antennae may include directional antennae, non-directional antennae, dipole antennae, folded dipole antennae, patch antennae, multiple-input multiple-output (MIMO) antennae, or the like. The antenna(e) 1334 may be communicatively coupled to one or more transceivers 1312 or radio components to which or from which signals may be transmitted or received.

As previously described, the antenna(e) 1334 may include a cellular antenna configured to transmit or receive signals in accordance with established standards and protocols, such as Global System for Mobile Communications (GSM), 3G standards (e.g., Universal Mobile Telecommunications System (UMTS), Wideband Code Division Multiple Access (W-CDMA), CDMA2000, etc.), 4G standards (e.g., Long-Term Evolution (LTE), WiMax, etc.), direct satellite communications, or the like.

The antenna(e) 1334 may additionally, or alternatively, include a WiFi antenna configured to transmit or receive signals in accordance with established standards and protocols, such as the IEEE 802.11 family of standards, including via 2.4 GHz channels (e.g., 802.11b, 802.11 g, 802.11n), 5 GHz channels (e.g., 802.11n, 802.11ac), or 60 GHz channels (e.g., 802.11ad). In alternative example embodiments, the antenna(e) 1334 may be configured to transmit or receive radio frequency signals within any suitable frequency range forming part of the unlicensed portion of the radio spectrum.

The antenna(e) 1334 may additionally, or alternatively, include a GNSS antenna configured to receive GNSS signals from three or more GNSS satellites carrying time-position information to triangulate a position therefrom. Such a GNSS antenna may be configured to receive GNSS signals from any current or planned GNSS such as, for example, the Global Positioning System (GPS), the GLONASS System, the Compass Navigation System, the Galileo System, or the Indian Regional Navigational System.

The transceiver(s) 1312 may include any suitable radio component(s) for—in cooperation with the antenna(e) 1334-transmitting or receiving radio frequency (RF) signals in the bandwidth and/or channels corresponding to the communications protocols utilized by the server(s) 1300 to communicate with other devices. The transceiver(s) 1312 may include hardware, software, and/or firmware for modulating, transmitting, or receiving-potentially in cooperation with any of antenna(e) 1334-communications signals according to any of the communications protocols discussed above including, but not limited to, one or more WiFi and/or WiFi direct protocols, as standardized by the IEEE 802.11 standards, one or more non-Wi-Fi protocols, or one or more cellular communications protocols or standards. The transceiver(s) 1312 may further include hardware, firmware, or software for receiving GNSS signals. The transceiver(s) 1312 may include any known receiver and baseband suitable for communicating via the communications protocols utilized by the server(s) 1300. The transceiver(s) 1312 may further include a low noise amplifier (LNA), additional signal amplifiers, an analog-to-digital (A/D) converter, one or more buffers, a digital baseband, or the like.

The sensor(s)/sensor interface(s) 1310 may include or may be capable of interfacing with any suitable type of sensing device such as, for example, inertial sensors, force sensors, thermal sensors, and so forth. Example types of inertial sensors may include accelerometers (e.g., MEMS-based accelerometers), gyroscopes, and so forth.

The speaker(s) 1314 may be any device configured to generate audible sound. The microphone(s) 1316 may be any device configured to receive analog sound input or voice data.

It should be appreciated that the program module(s), applications, computer-executable instructions, code, or the like depicted in FIG. 13 as being stored in the data storage 1320 are merely illustrative and not exhaustive and that processing described as being supported by any particular module may alternatively be distributed across multiple module(s) or performed by a different module. In addition, various program module(s), script(s), plug-in(s), application programming interface(s) (API(s)), or any other suitable computer-executable code hosted locally on the server(s) 1300, and/or hosted on other computing device(s) accessible via one or more networks, may be provided to support functionality provided by the program module(s), applications, or computer-executable code depicted in FIG. 13 and/or additional or alternate functionality. Further, functionality may be modularized differently such that processing described as being supported collectively by the collection of program module(s) depicted in FIG. 13 may be performed by a fewer or greater number of module(s), or functionality described as being supported by any particular module may be supported, at least in part, by another module. In addition, program module(s) that support the functionality described herein may form part of one or more applications executable across any number of systems or devices in accordance with any suitable computing model such as, for example, a client-server model, a peer-to-peer model, and so forth. In addition, any of the functionality described as being supported by any of the program module(s) depicted in FIG. 13 may be implemented, at least partially, in hardware and/or firmware across any number of devices.

It should further be appreciated that the server(s) 1300 may include alternate and/or additional hardware, software, or firmware components beyond those described or depicted without departing from the scope of the disclosure. More particularly, it should be appreciated that software, firmware, or hardware components depicted as forming part of the server(s) 1300 are merely illustrative and that some components may not be present or additional components may be provided in various embodiments. While various illustrative program module(s) have been depicted and described as software module(s) stored in the data storage 1320, it should be appreciated that functionality described as being supported by the program module(s) may be enabled by any combination of hardware, software, and/or firmware. It should further be appreciated that each of the above-mentioned module(s) may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other module(s). Further, one or more depicted module(s) may not be present in certain embodiments, while in other embodiments, additional module(s) not depicted may be present and may support at least a portion of the described functionality and/or additional functionality. Moreover, while certain module(s) may be depicted and described as sub-module(s) of another module, in certain embodiments, such module(s) may be provided as independent module(s) or as submodule(s) of other module(s).

One or more operations of the methods, process flows, and use cases of FIGS. 1-11 may be performed by a device having the illustrative configuration depicted in FIG. 13, or more specifically, by one or more engines, program module(s), applications, or the like executable on such a device. It should be appreciated, however, that such operations may be implemented in connection with numerous other device configurations.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Program module(s), applications, or the like disclosed herein may include one or more software components, including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines, and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program module(s), or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

That which is claimed:

1. A method comprising:
determining, via a processor, a first event impacting one or more users on a network;
determining, via the processor, a first time period during which the first event occurs;
determining, via the processor, a first number of interactions that occurred during the first time period between the one or more users and a network service provider;
determining, via the processor and using a correlation model, a first relationship between the first event and the first number of interactions during the first time period;
determining, via the processor, a second event impacting a first user; and
determining, using the correlation model and based on the second event, a first metric indicative of an experience of the first user, wherein the first event and second event are a same type of event.

2. The method of claim 1, further comprising:
automatically performing, via the processor, an action to remedy the second event prior to an interaction between the first user and the network service provider.

3. The method of claim 1, further comprising:
determining, via a processor, a third event associated with the network, where the third event is a different type of event than the first event;
determining, via the processor, a second time period during which the third event occurs;
determining, via the processor, a third number of interactions that occurred during the second time period;
determining, via the processor, a second relationship between the third event and the third number of interactions during the second time period; and
training the correlation model based on the second relationship.

4. The method of claim 1, wherein the one or more users include an aggregate of users.

5. The method of claim 1, wherein the correlation model includes a machine learning model, and wherein the method further comprises determining, using the machine learning model and based on a predicted future event, a predicted second metric indicative of a future experience of the first user.

6. The method of claim 5, further comprising:
determining a second metric indicative of a customer effort in initiating one or more interactions.

7. The method of claim 1, further comprising:
causing to present a user interface including the first metric.

8. A system comprising:
a processor; and
a memory storing computer-executable instructions that, when executed by the processor, cause the processor to:
determine a first event impacting one or more users on a network;
determine a first time period during which the first event occurs;
determine a first number of interactions that occurred during the first time period between the one or more users and a network service provider;
determine, using a correlation model, a first relationship between the first event and the first number of interactions during the first time period;
determine a second event impacting a first user; and
determine, using the correlation model and based on the second event, a first metric indicative of an experience of the first user, wherein the first event and second event are a same type of event.

9. The system of claim 8, wherein the computer-executable instructions further cause the processor to:
automatically perform, via the processor, an action to remedy the second event prior to an interaction between the first user and the network service provider.

10. The system of claim 8, wherein the computer-executable instructions further cause the processor to:
determine, via a processor, a third event associated with the network, where the third event is a different type of event than the first event;
determine, via the processor, a second time period during which the third event occurs;
determine, via the processor, a third number of interactions that occurred during the second time period;
determine, via the processor, a second relationship between the third event and the third number of interactions during the second time period; and
train the correlation model based on the second relationship.

11. The system of claim 8, wherein the one or more users include an aggregate of users.

12. The system of claim 8, wherein the correlation model includes a machine learning model, and wherein the computer-executable instructions further cause the processor to determine, using the machine learning model and based on a predicted future event, a predicted second metric indicative of a future experience of the first user.

13. The system of claim 12, wherein the computer-executable instructions further cause the processor to:
determine a second metric indicative of a customer effort in initiating one or more interactions.

14. The system of claim 8, wherein the computer-executable instructions further cause the processor to:
cause to present a user interface including the first metric.

15. A non-transitory computer-readable medium storing computer-executable instructions that, when executed by a processor, cause the processor to:
determine a first event impacting one or more users on a network;
determine a first time period during which the first event occurs;
determine a first number of interactions that occurred during the first time period between the one or more users and a network service provider;
determine, using a correlation model, a first relationship between the first event and the first number of interactions during the first time period;
determine a second event impacting a first user; and
determine, using the correlation model and based on the second event, a first metric indicative of an experience of the first user, wherein the first event and second event are a same type of event.

16. The non-transitory computer-readable medium of claim 15, wherein the computer-executable instructions further cause the processor to:
automatically perform, via the processor, an action to remedy the second event prior to an interaction between the first user and the network service provider.

17. The non-transitory computer-readable medium of claim 15, wherein the computer-executable instructions further cause the processor to:
determine, via a processor, a third event associated with the network, where the third event is a different type of event than the first event;
determine, via the processor, a second time period during which the third event occurs;
determine, via the processor, a third number of interactions that occurred during the second time period;
determine, via the processor, a second relationship between the third event and the third number of interactions during the second time period; and
train the correlation model based on the second relationship.

18. The non-transitory computer-readable medium of claim 15, wherein the one or more users include an aggregate of users.

19. The non-transitory computer-readable medium of claim 15, wherein the correlation model includes a machine learning model, and wherein the computer-executable instructions further cause the processor to determine, using the machine learning model and based on a predicted future event, a predicted second metric indicative of a future experience of the first user.

20. The non-transitory computer-readable medium of claim 19, wherein the computer-executable instructions further cause the processor to:
determine a second metric indicative of a customer effort in initiating one or more interactions.
